(19) United States
(12) Patent Application Publication
(10) Pub. No.: US 2020/0207949 A1
(43) Pub. Date: Jul. 2, 2020

(54) DOWNHOLE TOOL MEMBER AND MANUFACTURING METHOD THEREOF

(71) Applicant: Kureha Corporation, Tokyo (JP)

(72) Inventors: Takuma KOBAYASHI, Tokyo (JP); Fuminori KOBAYASHI, Tokyo (JP); Hikaru SAIJO, Tokyo (JP); Mizuki SAITO, Tokyo (JP); Hiroaki YOSHIDA, Tokyo (JP)

(73) Assignee: Kureha Corporation, Tokyo (JP)

(21) Appl. No.: 16/637,489

(22) PCT Filed: Jul. 23, 2018
(86) PCT No.: PCT/JP2018/027527

§ 371 Date: Feb. 7, 2020

(30) Foreign Application Priority Data
Sep. 22, 2017 (JP) 2017-182937
Mar. 8, 2018 (JP) 2018-042372

(51) Int. Cl. C08K 5/521; E21B 33/128; E21B 33/129

(52) U.S. Cl. CPC C08K 5/521; B29K 2067/043; E21B 33/1293; E21B 33/128

(57) ABSTRACT

Provided is a downhole tool member containing a polyglycolic acid resin composition that is easy to process during extrusion molding or injection molding, is able to reduce cracks during cutting and transportation, and has sufficient strength in a well in a high temperature environment. The downhole tool member according to an embodiment of the present invention contains a polyglycolic acid resin composition, in which a weight-average molecular weight Mw is from 150,000 to 300,000, and a melt viscosity My (Pa·s), measured at a temperature of 270° C. under a shearing speed of 122 sec⁻¹, satisfies Mv<6.2×10⁻¹⁵×Mw^{3.2}.

### TECHNICAL FIELD

An embodiment of the present invention relates to a polyglycolic acid resin composition, and its molded article and manufacturing method especially suitable for forming a downhole tool member.

### BACKGROUND ART

A polyglycolic acid resin composition is known as a material for a downhole tool member. In particular, since the downhole tool member such as a frac plug used for hydraulic fracturing is required to have high strength, its component is also required to have high strength.

WO 2014/192885 (Patent Document 1) discloses a polyglycolic acid resin composition having a high molecular weight and a high melt viscosity as a material capable of obtaining such a high-strength downhole tool member.

Moreover, machinery parts including the downhole tool member generally have a three-dimensional shape and a complicated shape. When a molded article having a three-dimensional shape or a complicated shape is manufactured from a resin material, it is often manufactured by an injection molding method. However, it has been found that when a three-dimensional molded article using the above-described high molecular weight and high melt viscosity polyglycolic acid resin composition is directly molded by an injection molding method, distortion and cracking occur. Therefore, in WO 2014/092067 (Patent Document 2), a stock shape of a polyglycolic acid resin composition having a simple shape is prepared by a solidification-extrusion method and is cut to form a downhole tool member containing the polyglycolic acid resin composition.

### CITATION LIST

### Patent Document

[Patent Document 1] WO 2014/192885 (Published on Dec. 4, 2014)
[Patent Document 2] WO 2014/092067 (Published on Jun. 19, 2014)

### SUMMARY OF INVENTION

### Technical Problem

An object of an embodiment of the present invention is to provide a downhole tool member containing a polyglycolic acid resin composition that is easy to process during extrusion molding or injection molding, can reduce cracks during cutting and transportation, and has sufficient strength in a well under a high temperature environment, and a manufacturing method thereof.

### Solution to Problem

As a result of intensive studies to solve the above problems, the present inventors have found that in a downhole tool member containing a polyglycolic acid resin composition, by using a polyglycolic acid resin composition in which a weight-average molecular weight Mw is from 150000 to 300000, and a melt viscosity My (Pa·s), measured at a temperature of 270° C. under a shearing speed of 122 sec⁻¹, satisfies Mv<6.2×10⁻¹⁵×Mw^{3.2}, a downhole tool member that is easy to mold and has a higher strength can be obtained.

Moreover, one aspect of the method for manufacturing a downhole tool member according to an embodiment of the present invention includes a step of injection-molding the polyglycolic acid resin composition.

### Advantageous Effects of Invention

According to an embodiment of the present invention, with a downhole tool member formed from a resin material containing polyglycolic acid in which a weight-average molecular weight Mw is from 150,000 to 300,000, and a melt viscosity My (Pa s), measured at a temperature of 270° C. under a shearing speed of 122 sec⁻¹, satisfies Mv<6.2×10⁻¹⁵×Mw^{3.2}, it is easy to process during extrusion molding or injection molding, and the production efficiency can be increased by reducing cracks during cutting and transportation, and reliability of the well treatment can be improved by having sufficient strength in a well under a high temperature environment. In addition, in the manufacturing method according to an embodiment of the present invention, it is possible to provide a downhole tool member that is easy to process during extrusion molding or injection molding, capable of reducing cracks during cutting and transportation, and has sufficient strength in a well in a high temperature environment.

### BRIEF DESCRIPTION OF THE DRAWINGS

FIG. 1 is a diagram schematically illustrating a cross section in an axial direction of a frac plug according to an embodiment of the present invention.

### DESCRIPTION OF EMBODIMENTS

### 1. Downhole Tool Member Containing Polyglycolic Acid Resin Composition Polyglycolic Acid Resin Composition

A polyglycolic acid resin composition according to the present embodiment has a weight-average molecular weight Mw from 150,000 to 300,000. When the weight-average molecular weight of the polyglycolic acid resin composition is 150,000 or greater, the strength of the downhole tool member can be sufficiently maintained, and when it is 300,000 or less, it is easy to mold during extrusion molding or injection molding can be performed.

The weight-average molecular weight of the polyglycolic acid resin composition is measured by a method described below. In hexafluoroisopropanol (HFIP), in which sodium trifluoroacetate is dissolved at a concentration of 5 mM, 10 mg of a sample is dissolved, making a 10 mL solution, and then the solution is filtered using a membrane filter to obtain a sample solution. By injecting 10 μL of the sample solution into a gel permeation chromatography (GPC) instrument, molecular weight of the sample solution is measured under the following conditions. Note that the sample is injected into the GPC instrument within 30 minutes after the sample is dissolved.

### GPC Measurement Conditions

Instrument: LC-9A, available from Shimadzu Corporation

Column: two HFIP-606M (connected in series), available from Showa Denko K.K.

Pre-column: one HFIP-G

Column Temperature: 40° C.

Eluent: HFIP solution in which sodium trifluoroacetate is dissolved at a concentration of 5 mM

Flow rate: 1 mL/min

Detector: differential refractometer

Molecular weight calibration: data of a molecular weight calibration curve produced by using five types of polymethylmethacrylates having standard molecular weights that are different from each other (available from Polymer Laboratories Ltd.) is used.

In addition, the melt viscosity My (Pa·s) measured at a temperature of 270° C. under a shearing speed of 122 sec⁻¹ of the polyglycolic acid resin composition in the present embodiment satisfies Mv<6.2×10⁻¹⁵×Mw^{3.2} (Formula 1).

Here, Mw satisfies the weight-average molecular weight of the polyglycolic acid resin composition. When the melt viscosity My satisfies the above (Formula 1), the polyglycolic acid resin composition can be easily processed by extrusion molding or injection molding. Furthermore, it is possible to reduce cracks when cutting extrusion-molded article or injection-molded article and cracks when transporting the molded articles.

Further, a polyglycolic acid resin composition in which the melt viscosity My (Pa·s) satisfies Mv<5.4×10⁻¹⁵×Mw^{3.2} (Formula 2) is more preferable. As a result, the polyglycolic acid resin composition can be more easily processed by extrusion molding or injection molding.

In addition, although a lower limit of the melt viscosity is not limited, from a viewpoint of obtaining sufficient strength of the molded article after extrusion molding or after injection molding, the melt viscosity is preferably 100 Pa·s or greater.

The melt viscosity of the polyglycolic acid resin composition measured at a temperature of 270° C. under a shearing speed of 122 sec⁻¹ is measured by the method described below. That is, using a pellet-shaped polyglycolic acid resin composition having a diameter of 3 mm and a length of 3 mm, the melt viscosity of a sample is measured by a capilograph equipped with a nozzle having a diameter (D) of 1.0 mm and length (L) of 10 mm (available from Toyo Seiki Seisaku-sho, Ltd.) at a temperature of 270° C. under a shearing speed of 122 sec⁻¹.

### Polyglycolic Acid

The polyglycolic acid used in the polyglycolic acid resin composition according to the present embodiment is a polymer containing a repeating unit represented by —(—O—CH₂—CO—)—. The polyglycolic acid may be a homopolymer of glycolic acid or a copolymer of glycolic acid and other monomer components. Examples of other monomer components used in the copolymer include hydroxycarboxylic acids such as L-lactic acid, D-lactic acid, 3-hydroxybutanoic acid, and 1-hydroxyhexanoic acid, an ester compound composed of a diol and a dicarboxylic acid, such as a condensate of 1,4-butanediol and succinic acid and a condensate of 1,4-butanediol and adipic acid, cyclic esters and lactones produced by intramolecular condensation of the other monomer components described above, and cyclic carbonates such as trimethylene carbonate.

In the case where polyglycolic acid is a copolymer of glycolic acid and other monomer components, the melt viscosity of the copolymer is preferably lower than the melt viscosity of a glycolic acid homopolymer having the same molecular weight as the copolymer. In a case where the copolymer has such a melt viscosity, there is no need to increase the melting temperature in the case of solidification-extrusion molding or injection molding using the polyglycolic acid resin composition, and a downhole tool member can be obtained satisfactorily.

The polyglycolic acid used in an embodiment of the present invention is preferably a high-molecular weight polymer. That is, the weight-average molecular weight of the polyglycolic acid used in the present embodiment is from 150,000 to 300,000, preferably from 160,000 to 290,000, more preferably from 170,000 to 280,000, even more preferably from 180,000 to 270,000, and particularly preferably from 185,000 to 260,000.

### Phosphorus Compound

The polyglycolic acid resin composition in the present embodiment can contain a phosphorus compound. The content of the phosphorus compound in a polyglycolic acid resin composition is preferably 700 ppm or greater, and more preferably 800 ppm or greater, relative to the polyglycolic acid resin. When the content of the phosphorus compound is within this range, the polyglycolic acid resin composition has a low melt viscosity at a temperature of 270° C. under a shearing speed of 122 sec⁻¹, thereby making the molding by extrusion molding or injection molding easy. Furthermore, when the content of the phosphorus compound is set to be 800 ppm or greater, it is possible to obtain a further effect of efficiently increasing the degradation rate without reducing the strength of the molded article. Further, the content of the phosphorus compound in the polyglycolic acid resin composition is preferably 3,000 ppm or less, and is more preferably 2,000 ppm or less, with respect to the polyglycolic acid resin from the viewpoint of preventing bleeding out of the phosphorus compound from the polyglycolic acid resin composition. Moreover, the phosphorus compound can be uniformly dispersed in a polyglycolic acid resin composition by setting the content to be 2,000 ppm or less. As a result, degradation of the downhole tool member can be made uniform, and local decomposition can be prevented.

The phosphorus compound is not particularly limited; however, the phosphorus compound is preferably an organic phosphorus compound such as phosphate and phosphite. Of these, the organic phosphorus compound having at least one chemical structure selected from the group consisting of a long-chain alkyl group having from 8 to 24 carbons, an aromatic ring, and a pentaerythritol skeleton is more preferable. One type of these phosphorus compounds may be used alone or two or more types of these phosphorus compounds may be used in combination.

Examples of the phosphate having a long-chain alkyl group having from 8 to 24 carbons include mono- or di-stearyl acid phosphate or its mixture, and di-2-ethylhexyl acid phosphate. Examples of the phosphite having an aromatic ring include tris(nonylphenyl) phosphite and the like. Examples of the phosphite having a pentaerythritol skeletal structure include cyclic neopentanetetraylbis(2,6-di-tert-butyl-4-methylphenyl)phosphite, cyclic neopentanetetraylbis(2,4-di-tert-butylphenyl)phosphite, and cyclic neopentanetetraylbis(octadecyl)phosphite.

As described above, the melt viscosity of the polyglycolic acid resin composition can be reduced by adding the phosphorus compound. As a result, the melt viscosity at a temperature of 270° C. under a shearing speed of 122 sec¹ of the polyglycolic acid resin composition can satisfy the above (Formula 1).

That is, a low melt viscosity can be achieved despite the high molecular weight.

### Degradation Accelerator

The polyglycolic acid resin composition in the present embodiment can contain a degradation accelerator. The degradation accelerator is a carboxylic acid anhydride or the above-described phosphorus compound, and as necessary, these can be used in combination with each other. By adding at least one of the carboxylic acid anhydride and the phosphorus compound as a degradation accelerator, a polyglycolic acid resin composition having excellent degradability even at low temperatures (e.g., lower than 60° C., and preferably lower than or equal to 50° C.) can be obtained. Furthermore, this polyglycolic acid resin composition also has excellent storing properties. In addition, by using the carboxylic acid anhydride and the phosphorus compound in combination with each other, the degradability tends to further increase.

### Carboxylic Acid Anhydride

The carboxylic acid anhydride used in the present embodiment is not particularly limited, and from the viewpoint of heat resistance that can tolerate the temperature at which the polyglycolic acid resin composition in the present embodiment is molded, and from the viewpoint of compatibility with the polyglycolic acid resin composition, the carboxylic acid anhydride having a ring structure is preferable, hexanoic anhydride, octanoic anhydride, decanoic anhydride, lauric anhydride, myristyl anhydride, palmitic anhydride, stearic anhydride, benzoic anhydride, succinic anhydride, maleic anhydride, phthalic anhydride, trimellitic anhydride, tetrahydrophthalic anhydride, butanetetracarboxylic dianhydride, 3,3′,4,4′-benzophenone tetracarboxylic dianhydride, diphenylsulfone tetracarboxylic dianhydride, biphenyl tetracarboxylic dianhydride, ethylene glycol bis-anhydro trimellitate, and glycerin bis-anhydro trimellitate monoacetate are more preferable, and Phthalic anhydride, trimellitic anhydride, benzoic anhydride, and 3,3′,4,4′-benzophenone tetracarboxylic dianhydride are particularly preferable. One type of these carboxylic acid anhydrides may be used alone or two or more types of these carboxylic acid anhydrides may be used in combination.

In addition, among these carboxylic acid anhydrides, a carboxylic acid anhydride that is capable of increasing the glass transition temperature (Tg) of the polyglycolic acid resin composition higher than the Tg of the polyglycolic acid contained in the polyglycolic acid resin composition is preferably used. An example of such a carboxylic acid anhydride includes a 3,3′,4,4′-benzophenone tetracarboxylic dianhydride. When the carboxylic acid anhydride that is capable of increasing a Tg is used, handleability upon molding the polyglycolic acid resin composition tends to be enhanced. For example, in the case where fibers are produced using a polyglycolic acid resin composition, sticking at the time of fiber production may be a problem. However, when the Tg of the polyglycolic acid resin composition is increased, sticking tends to occur rarely. The Tg of polyglycolic acid itself is generally −40° C. to 45° C., and for example, in the case where polyglycolic acid is a glycolic acid homopolymer, the Tg is generally 35° C. to 45° C. Here, when 3,3′,4,4′-benzophenone tetracarboxylic dianhydride is used as a degradation accelerator, a polyglycolic acid resin composition having a Tg from 45° C. to 55° C. can be obtained.

### Degradability of Downhole Tool Members

The downhole tool member according to the present embodiment is excellent in degradability. The degradability of the downhole tool member can be confirmed by the rate of decrease in thickness when a test piece having a thickness of 10 mm is immersed in water at a temperature of 66° C. When rate of decrease in thickness under these conditions is 0.02 mm/hr or greater, it can be confirmed that the molded product having an excellent degradability even in relatively low-temperature downhole environments such as a temperature of lower than 66° C., for example, so as to be degradable in a desired short amount of time.

The rate of decrease in thickness of the test piece having a thickness of 10 mm is specifically measured with the following method. That is, a required number of cubic test pieces each having a side of 10 mm are prepared by solidification-extrusion molding or injection molding. Next, the test piece is placed in a 1 L autoclave at a temperature of 66° C., and an immersion test is performed by filling the autoclave with water (deionized water). The test piece is retrieved after immersion at predetermined prescribed time intervals, and the cross-sectional surface is cut out. After the test piece is left to stand overnight in a dry room and dried, the thickness of the core part (hard portion) of the test piece is measured. The reduced thickness of the test piece is measured from the difference between the thickness before immersion (initial thickness, specifically 10 mm) and after immersion. The time variation in the decrease in thickness of the test piece is determined based on the measurements of the decrease in thickness of the test piece taken at different immersion times, and the rate of decrease in thickness in the test piece having a thickness of 10 mm is calculated from the time variation in the decrease in thickness of the test piece in a range over which linearity is observed in the time variation of the decrease in thickness of the test piece (unit: mm/hr).

When the rate of decrease in thickness of the test piece having a thickness of 10 mm is too small, the degradability of the downhole tool member is insufficient, and the degradability in relatively low-temperature downhole environments such as a temperature of lower than 66° C., for example, is insufficient, so the molded product cannot be degraded in a desired short amount of time. It can be said that the degradability of the downhole tool member is superior when the rate of decrease in thickness of a test piece having a thickness of 10 mm is preferably not less than 0.022 mm/hr and greater preferably not less than 0.03 mm/hr. The rate of decrease in thickness of the test piece having a thickness of 10 mm is not particularly limited, but is generally 0.3 mm/hr or less. When the rate of decrease in thickness of the test piece having a thickness of 10 mm is approximately 0.3 mm/hr or less, it is possible to reduce a risk that the seal function for a prescribed amount of time required for the downhole tool may not be expressed due to unforeseen early degradation, for example.

### Downhole Tool Member

The shape and size of the downhole tool member according to the present embodiment are not particularly limited, and for example, the thickness or diameter is from 5 to 500 mm, preferably from 20 to 300 mm, and more preferably from 30 to 200 mm. In addition, the downhole tool members having various shapes such as a round bar shape, a flat plate shape, a hollow product such as a pipe, and a deformed product can be obtained. A round bar, a hollow shape, or a flat plate shape is preferable, as it is easy to perform extrusion molding and a subsequent densification treatment and is often suitable for an extrusion-molded article that is a material for machining. In order to form a downhole tool member for petroleum drilling, particularly a mandrel of a sealing plug, a round bar shape is more preferable.

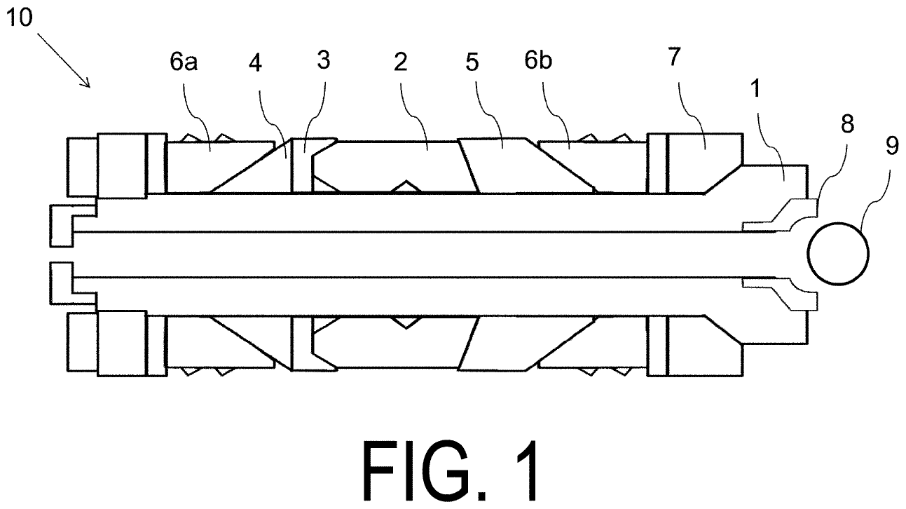

The downhole tool member according to the present embodiment can be used as a member of a frac plug. Especially, it is preferable to use as a mandrel, load ring, socket, cone, ball or ball seat for a frac plug. The frac plug provided with the downhole tool member according to the present embodiment will be described referring to FIG. 1.

FIG. 1 is a diagram schematically illustrating a cross section in an axial direction of the frac plug. The frac plug 10 is a downhole tool used to seal a wellbore (not illustrated), and includes a mandrel 1 (tubular member), a seal member (elastic member) 2, and a socket (holding member) 3, cones 4 and 5, a pair of slips 6a and 6b, a load ring 7, and a ball seat 8.

The mandrel 1 is a member for ensuring the strength of the frac plug 10 and has a hollow shape. The mandrel 1 can have a processed portion on at least one of the outer peripheral surface and the inner peripheral surface. Here, the processed portion refers to at least one of a convex portion, a step portion, a concave portion (groove portion), and a screw portion, for instance.

The seal member 2 is an annular rubber member, and is attached on the outer peripheral surface in the axial direction of the mandrel 1 between the socket 3 and the cone 5. The seal member 2 is deformed when the frac plug 10 receives pressure, seals the gap between the frac plug 10 and a casing, and can restrict the fluid flow in the well.

The socket 3 is an annular member, and is attached on the outer peripheral surface in the axial direction of the mandrel 1 adjacent to the seal member 2 on the downstream side of the pressure that the seal member 2 receives in the axial direction.

The cones 4 and 5 are formed such that the slips 6a and 6b slide on the inclined surfaces of the cones 4 and 5 in the case where a load or pressure is applied to the pair of slips 6a and 6b toward the seal member 2 side.

The load ring 7 is an annular member, and is a member that transmits a load from a setting tool used for installation to the slip 6b toward the seal member 2 when the frac plug 10 is installed in the well.

The ball seat 8 has a surface for receiving the ball 9 and is attached to the mandrel 1. The ball seat 8 can be fixed to, for example, a screw portion carved on the hollow inner peripheral surface of the mandrel 1. Further, the mandrel and the ball seat can be formed integrally without being separated from each other. During the well treatment using the frac plug 10, the ball 9 is supplied to the ball seat 8 and the ball 9 is seated on the seat surface, thereby sealing the hollow portion of the mandrel 1 which is also a flow path of the frac plug 10.

The ball 9 is seated on the ball seat 8 to seal the hollow portion of the mandrel 1 which is also a flow path of the frac plug 10. The shape of the ball 9 is usually spherical, but the shape is not limited as long as the ball 9 can be seated on the ball seat 8 to seal the hollow portion of the mandrel 1. For example, the ball 9 can be shaped like a sphere or a dart. By using the downhole tool member according to the present embodiment in the frac plug 10 as the mandrel 1, the seal member 2, the socket 3, the cones 4 and 5, the pair of slips 6a and 6b, the load ring 7, and the ball seat 8, frac plug 10 secures the strength that can tolerate a pressure of 10,000 psi in the well, and after the well treatment is performed using the frac plug 10, the frac plug 10 can be easily removed.

As described above, the downhole tool member in the present embodiment is a member constituting a downhole tool (for example, a frac plug) used for petroleum drilling, and is a relatively large member. Moreover, in such a member, the effect by using the above-described composition is exhibited. Therefore, for example, pellets, fibers and powders, in particular, pellets having a thickness of less than 5 mm, and fibers and powders having a diameter of less than 5 mm do not correspond to the downhole tool in the present embodiment.

### [Crushing Strength at Temperature of 23° C.]

The crushing strength of the downhole tool member according to the present embodiment at a temperature of 23° C. is from 40 to 100 kN, preferably from 40 to 95 kN, more preferably from 42 to 90 kN, still more preferably from 45 to 85 kN, and particularly preferably from 45 to 80 kN.

The crushing test of the downhole tool member at a temperature of 23° C. is performed using a test piece obtained by processing the downhole tool member into a thick cylindrical shape having an outer diameter of 70.4 mm, an inner diameter of 30 mm, and a length of 30 mm, or a test piece obtained by processing a polyglycolic acid resin material which is the same as the downhole tool member into a thick cylindrical shape having an outer diameter of 70.4 mm, an inner diameter of 30 mm, and a length of 30 mm. The load is measured by compressing the test piece at a speed of 10 mm/min from a state in which the side surface of the thick cylindrical test piece is sandwiched between the upper and lower compression plates of the compression tester until the test piece is crushed, and then, the maximum point load is set the crushing strength.

Since the crushing strength of the downhole tool member according to the present embodiment at 23° C. is 40 to 100 kN, the downhole tool member has a sufficient strength even in a high temperature environment exceeding the temperature of 100° C., for example, underground having a depth exceeding 3000 m.

For example, since the mandrel of the sealing plug, which is one of the downhole tool members, often has a hollow shape, the mandrel supports the high load with the cross-sectional area of the hollow cross section. In a case where the crushing strength of the downhole tool member at 23° C. is 30 kN or greater, it means that the cross-sectional area of the hollow cross section of the mandrel of the sealing plug is approximately 2,450 mm², and that the mandrel can tolerate a load is approximately 5,000 kgf (about 49,000 N) in an environment at a temperature of 150° C. However, in the case where the mandrel has a minute split or crack, the mandrel is broken without being able to tolerate the pressure in the well, which may cause problems in the well treatment. However, in a case where the crushing strength of the downhole tool member at 23° C. is 40 kN or greater as in the present embodiment, it can tolerate the pressure in the well even if there is a minute split or crack, and the well treatment can be more reliably implemented.

Therefore, the downhole tool member formed of a resin material containing polyglycolic acid in which a weight-average molecular weight Mw from 150,000 to 300,000, and a melt viscosity Mv, measured at a temperature of 270° C. under a shearing speed of 122 sec⁻¹, satisfies Mv<6.2×10⁻¹⁵×Mw^{3.2} can sufficiently tolerate the stress applied to the mandrel of the sealing plug having a usual size (cross-sectional area) in underground having a depth exceeding 3,000 m (under a temperature of about 100° C.). In many cases, it is difficult to manufacture and machine the downhole tool member having a crushing strength exceeding 100 kN at 23° C.

### 2. Method for Manufacturing Downhole Tool Member

The downhole tool member of the present embodiment can be manufactured by solidification-extrusion molding or injection molding. In the method for manufacturing the downhole tool member of the present embodiment, by using a polyglycolic acid resin composition in which a weight-average molecular weight Mw is from 150,000 to 300,000, and a melt viscosity Mv, measured at a temperature of 270° C. under a shearing speed of 122 sec⁻¹, satisfies Mv<6.2×10⁻¹⁵×Mw^{3.2}, a downhole tool member that can be molded at a mild temperature can prevent deformation after molding, and a downhole tool having high strength can be obtained.

### Manufacture of Downhole Tool Member by Solidification-Extrusion Molding

The downhole tool member of the present embodiment can be manufactured by solidification-extrusion molding using the above-described polyglycolic acid resin composition. Pellets made of the above-described polyglycolic acid resin composition (melting point Tm° C.) are supplied to an extruder having a cylinder temperature Tm to 255° C. (usually 200° C. to 255° C.) and melt kneaded. When the cylinder temperature is 255° C. or lower, the thermal degradation of the polymer can be suppressed, and thereby a rapid decrease in molecular weight and foaming associated with the thermal degradation can be suppressed. As a result, it is possible to prevent the mechanical properties of a solidification- and extrusion-molded article to be obtained from being significantly deteriorated. In some cases, a blended article of polyglycolic acid pellets and additives such as the above-described phosphorus compound and degradation accelerator is supplied to the extruder and melt-kneaded, so that a melt-kneaded article of the above-described polyglycolic acid resin composition may be manufactured in the extruder. Next, the melt-kneaded article is extruded from the extrusion die at the tip of the extruder into the flow path of a forming die, and cooled and solidified below the crystallization temperature of the polyglycolic acid resin composition in the flow path of the forming die, so that the resultant is extruded to the outside at a speed from 5 to 50 mm/10 minutes from the tip of the forming die. The solidification- and extrusion-molded article can be manufactured by pressurizing and pulling the extrudate while applying a back pressure from 1,500 to 8,500 kg toward the forming die. The molded article may be annealed by a heat treatment at a temperature of 150° C. to 230° C. for 3 to 24 hours.

The obtained solidification- and extrusion-molded article can be used as it is, as a downhole tool member, or can be further subjected to appropriate machining to obtain a downhole tool member. Examples of the machining that can be performed on the solidification- and extrusion-molded article include cutting, drilling, shearing, and combinations thereof. Broadly speaking, the cutting method may include drilling, in addition to cutting. Examples of the cutting method include turning, grinding, lathing, and boring performed by using a single cutter. Examples of the cutting method making use of a multi-cutter include milling, drilling, thread cutting, gear cutting, diesinking and filing. In the present embodiment, drilling making use of a drill may be distinguished from the cutting in some cases. Examples of the shearing method include shearing by a cutting tool (saw), shearing by abrasive grains and shearing by heating and melting. In addition, ground finishing methods, plastic working methods such as punching making use of a knife-like tool and marking-off shearing, special working methods such as laser beam machining may also be applied.

For the cases where the solidification- and extrusion-molded article has a plate, round bar, or hollow shape having a large thickness, as machining, the solidification- and extrusion-molded article is typically shorn into a proper size or thickness, the shorn solidification- and extrusion-molded article is ground to adjust its shape to a desired shape, and, as necessary, some parts of the solidification- and extrusion-molded article are further subjected to drilling. The solid-state extrusion molded article is finally subjected to a finishing operation as necessary. However, the order of the machining is not limited to this order.

In the case where the downhole tool member is manufactured by processing the solidification- and extrusion-molded article in this way, for example, in order to obtain a downhole tool member having a thickness or diameter from 5 to 500 mm, the thickness or diameter of the solidification- and extrusion-molded article may be from 5 to 550 mm. At that time, a solidification- and extrusion-molded article having the same thickness or diameter as that of the downhole tool member may be used, and in order to obtain a beautiful surface by machining, a solidification- and extrusion-molded article having a thickness or diameter larger than that of the downhole tool member may be used. In particular, since a cutting margin during machining can be reduced, a difference in the thickness or diameter between the solidification- and extrusion-molded article and the downhole tool member is preferably small, and specifically, it is preferably from 0 to 50 mm.

When a smooth surface is hard to be formed because of melting of the solidification- and extrusion-molded article due to frictional heat upon the machining, the machining is desirably performed while cooling a cut surface, for instance. Excessive heat generated on the solidification- and extrusion-molded article by frictional heat can cause deformation or discoloration. Therefore, it is preferable to control the temperature of the solidification- and extrusion-molded article or surface to be machined to a temperature of 200° C. or lower, and more preferably to a temperature of 150° C. or lower.

### Manufacture of Downhole Tool Member by Injection Molding

The downhole tool member of the present embodiment can be also manufactured by injection molding using the above-described polyglycolic acid resin composition. Pellets made of the polyglycolic acid resin composition described above are supplied to an injection molding machine equipped with an injection mold, injection-molded at a cylinder temperature Tm to 255° C. (usually 150° C. to 255° C.), and a mold temperature 0° C. to Tm (usually 0° C. to 190° C.), and an injection pressure from 1 to 104 MPa (preferably from 10 to 104 MPa), and, as necessary, annealed at a crystallization temperature Tc1 to Tm (usually 70° C. to 220° C.) for 1 minute to 10 hours, thereby obtaining an injection-molded article. In some cases, a blended article of polyglycolic acid pellets and additives such as the above-described phosphorus compound and degradation accelerator is supplied to the injection molding machine and melt-kneaded, so that a melt-kneaded article of the above-described polyglycolic acid resin composition is manufactured in the extruder, and subsequently the injection molding may be performed to manufacture an injection-molded article.

When the cylinder temperature is 255° C. or lower, the thermal degradation of the polymer can be suppressed, and thereby a rapid decrease in molecular weight and foaming associated with the thermal degradation can be avoided. As a result, it is possible to prevent the significant deterioration of the mechanical properties of the injection-molded article to be obtained. The obtained injection-molded article can usually be used as a downhole tool member as it is, but can also be used as a downhole tool member by performing the above-described machining if desired. By using the polyglycolic acid resin composition of the present embodiment, it is possible to obtain a downhole tool member that is less likely to be cracked and distorted even by the injection molding.

### 3. Summary

As is apparent from the above, the present inventions include the following.

A downhole tool member containing a polyglycolic acid resin composition, in which a weight-average molecular weight Mw is from 150,000 to 300,000, and a melt viscosity My (Pa·s), measured at a temperature of 270° C. under a shearing speed of 122 sec⁻¹, satisfies Mv<6.2×10⁻¹⁵×Mw^{3.2}.

By using the above-described polyglycolic acid resin composition, it is possible to obtain a downhole tool member that is easy to mold and has high strength.

In one aspect of an embodiment of the present invention, the polyglycolic acid resin composition preferably has the melt viscosity My satisfying Mv<5.4×10⁻¹⁵×Mw^{3.2}.

In one aspect of an embodiment of the present invention, the polyglycolic acid resin composition is preferably a polyglycolic acid resin composition having, as a molded article molded from the polyglycolic acid resin composition, a crushing strength of 40 kN or more in a crushing test at 23° C.

In one aspect of an embodiment of the present invention, the downhole tool member may have a rate of decrease in thickness from 0.03 mm/h to 0.3 mm/h in water of 66° C.

In one aspect of an embodiment of the present invention, the polyglycolic acid resin composition is preferably a composition containing a polyglycolic acid resin and a phosphorus compound of 700 ppm or greater relative to the polyglycolic acid resin.

In one aspect of an embodiment of the invention, the downhole tool member may be a mandrel, a load ring, a socket, a cone, a ball, or a ball seat for a frac plug.

Moreover, one aspect of the method for manufacturing a downhole tool member according to an embodiment of the present invention includes a step of injection-molding the polyglycolic acid resin composition.

Moreover, another aspect of the method for manufacturing a downhole tool member according to an embodiment of the present invention includes a step of solidification-extrusion molding the polyglycolic acid resin composition.

### EXAMPLES

The present inventions will be described in further detail hereinafter using examples, a comparative example, and reference examples. However, the present inventions are not to be limited by those examples.

### Example 1

2 parts by mass of 3,3′,4,4′-benzophenone tetracarboxylic dianhydride (BTDA) (available from Evonik Degussa Gmbh) was used as a carboxylic acid anhydride with respect to 98 parts by mass of polyglycolic acid (PGA, “Kuredux” available from Kureha Corporation, weight-average molecular weight (Mw): 241,000), and a mixture of distearyl acid phosphate and monostearyl acid phosphate (“ADEKA STAB AX-71” available from ADEKA) as a phosphorus compound were blended. The blended article was supplied to a feed part of a twin-screw extrusion kneader (“2D25S” available from Toyo Seiki Seisaku-sho, Ltd.) set at a screw temperature of 200° C. to 240° C., and melt kneaded to obtain a pellet-shaped polyglycolic acid resin composition. In addition, the content of the phosphorus compound was 900 ppm relative to the entire content of polyglycolic acid resin composition.

This polyglycolic acid resin composition had a weight-average molecular weight of 226,000 and a melt viscosity of 640 Pa·s measured at a temperature of 270° C. and a shearing speed of 122 sec⁻¹. Therefore, the melt viscosity of the polyglycolic acid resin composition satisfied the above (Formula 1) and (Formula 2).

The pellets of the polyglycolic acid resin composition were dehumidified and dried at a temperature of 140° C. for 6 hours. A constant feeder was placed, and the dehumidified and dried pellets were supplied to a hopper of the constant feeder to supply the pellets to a supplying part of a single screw extruder (L/D=20; diameter: 30 mm) at a constant rate. The pellets were melt-kneaded at a cylinder temperature of 251° C. At an extrusion die outlet temperature of 276° C., it was melt-extruded into the flow path of the forming die, cooled at a cooling temperature of 90° C., and solidified. The extrusion rate was approximately 20 mm/10 minutes.

By pressurizing the solidification- and extrusion-molded article that was solidified in the flow path of the forming die by passing the solidification- and extrusion-molded article in between upper rolls and lower rolls, expansion of the solidification- and extrusion-molded article were suppressed by adjusting the external pressure (back pressure) of the forming die to be 3,100 kg. Thereafter, the solidification- and extrusion-molded article was heat-treated at a temperature of 215° C. for 6 hours to remove residual stress. The heat treatment did not crack or deform the solidification- and extrusion-molded article.

By the method as described above, a round bar-shaped solidification- and extrusion-molded article of polyglycolic acid having a diameter of 90 mm and a length of 1000 mm was obtained. A thick cylindrical test piece having a diameter of 70.4 mm, an inner diameter of 30 mm, and a length of 30 mm was cut out from the obtained round bar, and the 23° C. crushing strength was measured. As a result, it was 70.5 kN. Further, a cubic test piece having 10 mm in each side was cut out from this round bar, and the test piece was put into a 1 L-autoclave at a temperature of 66° C. and filled with water (deionized water). As a result, the rate of decrease in thickness was 0.0535 mm/hr.

Using the round bar described above, 50 hollow bodies in which two regions within 200 mm from each end had an outer diameter of 90 mm and inner diameter of 30 mm and the rest (600 mm) had an outer diameter of 80 mm and inner diameter of 30 mm were manufactured by hollowing and by machining (cutting) the outer diameter using an HSS tool bit. All of them did not induce cracking during processing.

Pellets made of the polyglycolic acid resin composition described above were supplied to an injection molding machine equipped with an injection mold, and injection-molded at a cylinder temperature of 245° C., a mold temperature of 180° C., and an injection pressure of 90 MPa, and annealed at a temperature of 170° C. for 3 hours. An injection-molded article of a JIS No. 6 tensile dumbbell piece was then obtained. The obtained injection-molded article was not deformed after annealing.

### Example 2

A pellet polyglycolic acid resin composition was obtained in the same manner as in Example 1 except that 1 part by mass of BTDA was blended as carboxylic acid anhydride with respect to 99 parts by mass of polyglycolic acid, and “ADEKA STAB AX-71” was blended as a phosphorus compound to be 1,400 ppm.

This polyglycolic acid resin composition had a weight-average molecular weight of 197,000 and a melt viscosity of 340 Pa·s measured at a temperature of 270° C. and a shearing speed of 122 sec⁻¹. Therefore, the melt viscosity of the polyglycolic acid resin composition satisfied the above (Formula 1) and (Formula 2). Using the pellets of the polyglycolic acid resin composition, a round bar-shaped polyglycolic acid solidification- and extrusion-molded article was obtained in the same manner as in Example 1.

A thick cylindrical test piece was cut out from the obtained round bar, and the 23° C. crushing strength was measured. As a result, it was 67.2 kN. When a cubic test piece was cut out from the obtained round bar and subjected to an immersion test in water at 66° C., the rate of decrease in thickness was 0.0468 mm/hr. When 50 hollow bodies were manufactured from this round bar-shaped polyglycolic acid solidification- and extrusion-molded article in the same manner as in Example 1, no cracks were induced during processing in all of them.

Moreover, using the pellets of the polyglycolic acid resin composition, an injection-molded article of a tensile dumbbell piece was obtained in the same manner as in Example 1. The obtained injection-molded article was not deformed after annealing.

### Example 3

A pellet polyglycolic acid resin composition was obtained in the same manner as in Example 1 except that 3 parts by mass of BTDA was blended as carboxylic acid anhydride with respect to 97 parts by mass of polyglycolic acid, and “ADEKA STAB AX-71” was blended as a phosphorus compound to be 1,400 ppm.

This polyglycolic acid resin composition had a weight-average molecular weight of 200,000 and a melt viscosity of 395 Pa·s measured at a temperature of 270° C. and a shearing speed of 122 sec⁻¹. Therefore, the melt viscosity of the polyglycolic acid resin composition satisfied the above (Formula 1) and (Formula 2).

Using the pellets of the polyglycolic acid resin composition, a round bar-shaped polyglycolic acid solidification- and extrusion-molded article was obtained in the same manner as in Example 1. A thick cylindrical test piece was cut out from the obtained round bar, and the 23° C. crushing strength was measured. As a result, it was 59.2 kN. When the cubic test piece was cut out from the obtained round bar and subjected to the immersion test in water at 66° C., the rate of decrease in thickness was 0.0562 mm/hr. When 50 hollow bodies were manufactured from this round bar-shaped polyglycolic acid solidification- and extrusion-molded article in the same manner as in Example 1, no cracks were induced during processing in all of them.

Moreover, using the pellets of the polyglycolic acid resin composition, an injection-molded article of a tensile dumbbell piece was obtained in the same manner as in Example 1. The obtained injection-molded article was not deformed after annealing.

### Example 4

A pellet polyglycolic acid resin composition was obtained in the same manner as in Example 1 except that 3 parts by mass of BTDA was blended as carboxylic acid anhydride with respect to 97 parts by mass of polyglycolic acid, and “ADEKA STAB AX-71” was blended as a phosphorus compound to be 1,700 ppm.

This polyglycolic acid resin composition had a weight-average molecular weight of 216,000 and a melt viscosity of 438 Pa·s measured at a temperature of 270° C. and a shearing speed of 122 sec⁻¹. Therefore, the melt viscosity of the polyglycolic acid resin composition satisfied the above (Formula 1) and (Formula 2).

Using the pellets of the polyglycolic acid resin composition, a round bar-shaped polyglycolic acid solidification- and extrusion-molded article was obtained in the same manner as in Example 1. A thick cylindrical test piece was cut out from the obtained round bar, and the 23° C. crushing strength was measured. As a result, it was 64.7 kN. When the cubic test piece was cut out from the obtained round bar and subjected to the immersion test in water at 66° C., the rate of decrease in thickness was 0.0665 mm/hr. When 50 hollow bodies were manufactured from this round bar-shaped polyglycolic acid solidification- and extrusion-molded article in the same manner as in Example 1, no cracks were induced during processing in all of them.

Moreover, using the pellets of the polyglycolic acid resin composition, an injection-molded article of a tensile dumbbell piece was obtained in the same manner as in Example 1. The obtained injection-molded article was not deformed after annealing.

### Example 5

A pellet polyglycolic acid resin composition was obtained in the same manner as in Example 1 except that 5 parts by mass of BTDA was blended as carboxylic acid anhydride with respect to 95 parts by mass of polyglycolic acid, and “ADEKA STAB AX-71” was blended as a phosphorus compound to be 1,480 ppm.

This polyglycolic acid resin composition had a weight-average molecular weight of 194,000 and a melt viscosity of 326 Pa·s measured at a temperature of 270° C. and a shearing speed of 122 sec⁻¹. Therefore, the melt viscosity of the polyglycolic acid resin composition satisfied the above (Formula 1) and (Formula 2).

Using the pellets of the polyglycolic acid resin composition, a round bar-shaped polyglycolic acid solidification- and extrusion-molded article was obtained in the same manner as in Example 1. A thick cylindrical test piece was cut out from the obtained round bar, and the 23° C. crushing strength was measured. As a result, it was 52.8 kN. When the cubic test piece was cut out from the obtained round bar and subjected to the immersion test in water at 66° C., the rate of decrease in thickness was 0.0689 mm/hr. When 50 hollow bodies were manufactured from this round bar-shaped polyglycolic acid solidification- and extrusion-molded article in the same manner as in Example 1, no cracks were induced during processing in all of them.

Moreover, using the pellets of the polyglycolic acid resin composition, an injection-molded article of a tensile dumbbell piece was obtained in the same manner as in Example 1. The obtained injection-molded article was not deformed after annealing.

### Example 6

A pellet polyglycolic acid resin composition was obtained in the same manner as in Example 1 except that “ADEKA STAB AX-71” was blended as a phosphorus compound to be 3,000 ppm without blending BTDA.

This polyglycolic acid resin composition had a weight-average molecular weight of 216,000 and a melt viscosity of 473 Pa·s measured at a temperature of 270° C. and a shearing speed of 122 sec⁻¹. Therefore, the melt viscosity of the polyglycolic acid resin composition satisfied the above (Formula 1) and (Formula 2).

Moreover, using the pellets of the polyglycolic acid resin composition, an injection-molded article of a tensile dumbbell piece was obtained in the same manner as in Example 1. The obtained injection-molded article was not deformed after annealing.

Further, a rectangular parallelepiped test piece having a width of 10 mm, a depth of 10 mm, and a thickness of 3 mm was cut out from the tensile dumbbell piece, and the test piece was put into a 1 L-autoclave at a temperature of 66° C. and filled with water (deionized water). As a result, the rate of decrease in thickness was 0.0578 mm/hr.

### Comparative Example 1

A pellet polyglycolic acid resin composition was obtained in the same manner as in Example 1 except that “ADEKA STAB AX-71” was blended as a phosphorus compound to be 200 ppm without blending BTDA.

This polyglycolic acid resin composition had a weight-average molecular weight of 230,000 and a melt viscosity of 920 Pa·s measured at a temperature of 270° C. and a shearing speed of 122 sec⁻¹. Therefore, the melt viscosity of the polyglycolic acid resin composition did not satisfy the above (Formula 1) and (Formula 2).

Using the pellets of the polyglycolic acid resin composition, a round bar-shaped polyglycolic acid solidification- and extrusion-molded article was obtained in the same manner as in Example 1. A thick cylindrical test piece was cut out from the obtained round bar, and the 23° C. crushing strength was measured. As a result, it was 75.2 kN. When the cubic test piece was cut out from the obtained round bar and subjected to the immersion test in water at 66° C., the rate of decrease in thickness was 0.0234 mm/hr. When 50 hollow bodies were manufactured from this round bar-shaped polyglycolic acid solidification- and extrusion-molded article in the same manner as in Example 1, no cracks were induced during processing in all of them.

In addition, using the pellets of the polyglycolic acid resin composition, an injection-molded article of a tensile dumbbell piece was obtained in the same manner as in Example 1. However, the mold was not sufficiently filled with the resin, and a target injection-molded article was not obtained. Subsequently, in order to lower the melt viscosity at the time of molding, an injection-molded article of a tensile dumbbell piece was obtained in the same manner as in Example 1 except that the cylinder temperature was changed to 255° C. The obtained injection-molded piece was deformed after annealing.

### Comparative Example 2

A pellet polyglycolic acid resin composition was obtained in the same manner as in Example 1 except that 5 parts by mass of BTDA was blended as carboxylic acid anhydride with respect to 95 parts by mass of polyglycolic acid, and “ADEKA STAB AX-71” was blended as a phosphorus compound to be 200 ppm.

This polyglycolic acid resin composition had a weight-average molecular weight of 210,000 and a melt viscosity of 850 Pa·s measured at a temperature of 270° C. and a shearing speed of 122 sec⁻¹. Therefore, the melt viscosity of the polyglycolic acid resin composition did not satisfy the above (Formula 1) and (Formula 2).

Using the pellets of the polyglycolic acid resin composition, a round bar-shaped polyglycolic acid solidification- and extrusion-molded article was obtained in the same manner as in Example 1. A thick cylindrical test piece was cut out from the obtained round bar, and the 23° C. crushing strength was measured. As a result, it was 57.2 kN. When the cubic test piece was cut out from the obtained round bar and subjected to the immersion test in water at 66° C., the rate of decrease in thickness was 0.0536 mm/hr. When 50 hollow bodies were manufactured from this round bar-shaped polyglycolic acid solidification- and extrusion-molded article in the same manner as in Example 1, no cracks were induced during processing in all of them.

In addition, using the pellets of the polyglycolic acid resin composition, an injection-molded article of a tensile dumbbell piece was obtained in the same manner as in Example 1. However, the mold was not sufficiently filled with the resin, and a target injection-molded article was not obtained. Subsequently, in order to lower the melt viscosity at the time of molding, an injection-molded article of a tensile dumbbell piece was obtained in the same manner as in Example 1 except that the cylinder temperature was changed to 255° C. The obtained injection-molded piece was deformed after annealing.

### Comparative Example 3

A pellet polyglycolic acid resin composition was obtained in the same manner as in Example 1 except that 4 parts by mass of BTDA was blended as carboxylic acid anhydride with respect to 96 parts by mass of polyglycolic acid, and “ADEKA STAB AX-71” was blended as a phosphorus compound to be 200 ppm.

This polyglycolic acid resin composition had a weight-average molecular weight of 223,000 and a melt viscosity of 1,155 Pa·s measured at a temperature of 270° C. and a shearing speed of 122 sec⁻¹. Therefore, the melt viscosity of the polyglycolic acid resin composition did not satisfy the above (Formula 1) and (Formula 2).

Using the pellets of the polyglycolic acid resin composition, a round bar-shaped polyglycolic acid solidification- and extrusion-molded article was obtained in the same manner as in Example 1. A thick cylindrical test piece was cut out from the obtained round bar, and the 23° C. crushing strength was measured. As a result, it was 33.3 kN. When the cubic test piece was cut out from the obtained round bar and subjected to the immersion test in water at 66° C., the rate of decrease in thickness was 0.0479 mm/hr. When 50 hollow bodies were manufactured from this round bar-shaped polyglycolic acid solidification- and extrusion-molded article in the same manner as in Example 1, cracks occurred during processing of two of them, and the crack occurrence rate was 4%.

In addition, using the pellets of the polyglycolic acid resin composition, an injection-molded article of a tensile dumbbell piece was obtained in the same manner as in Example 1. However, the mold was not sufficiently filled with the resin, and a target injection-molded article was not obtained. Subsequently, in order to lower the melt viscosity at the time of molding, an injection-molded article of a tensile dumbbell piece was obtained in the same manner as in Example 1 except that the cylinder temperature was changed to 255° C. The obtained injection-molded piece was deformed after annealing.

The results of the above examples and comparative examples are summarized in Table 1.

TABLE 1

| | Polyglycolic acid resin | | | | | | | | | | Rate of decrease |
|---|---|---|---|---|---|---|---|---|---|---|---|
| | composition | | | Melt | | 6.2 × | 5.4 × | | Crushing | Processing | in thickness at |
| | (part | BTDA | AX-71 | viscosity Mv | Molecular | 10⁻¹⁵ × | 10⁻¹⁵ × | Injection | strength | crack ratio | 66° C. |
| | by [symbol] | (part by mass) | (ppm) | (Pa · s) | weight Mw | Mw^{3.2} | Mw^{3.2} | molding | (kN) | (%) | (mm/h) |
| Example 1 | 98 | 2 | 900 | 640 | 226 × 10³ | 842 | 734 | Good | 70.5 | 0 | 0.0535 |
| Example 2 | 99 | 1 | 1400 | 340 | 197 × 10³ | 543 | 473 | Good | 67.2 | 0 | 0.0468 |
| Example 3 | 97 | 3 | 1400 | 395 | 200 × 10³ | 570 | 496 | Good | 59.2 | 0 | 0.0562 |
| Example 4 | 97 | 3 | 1700 | 438 | 216 × 10³ | 729 | 635 | Good | 64.7 | 0 | 0.0665 |
| Example 5 | 95 | 5 | 1480 | 326 | 194 × 10³ | 517 | 450 | Good | 52.8 | 0 | 0.0689 |
| Example 6 | 100 | 0 | 3000 | 473 | 216 × 10³ | 729 | 635 | Good | | | 0.0578 |
| Comparative | 100 | 0 | 200 | 920 | 230 × 10³ | 891 | 776 | Bad | 75.2 | 0 | 0.0234 |
| Example 1 | | | | | | | | | | | |
| Comparative | 95 | 5 | 200 | 850 | 210 × 10³ | 666 | 580 | Bad | 57.2 | 0 | 0.0536 |
| Example 2 | | | | | | | | | | | |
| Comparative | 96 | 4 | 200 | 1155 | 223 × 10³ | 807 | 703 | Bad | 33.3 | 4 | 0.0479 |
| Example 3 | | | | | | | | | | | |

[symbol]

indicates data missing or illegible when filed

From Examples 1 to 6, it was found that in the downhole tool member containing the polyglycolic acid resin composition, a downhole tool member containing a polyglycolic acid resin composition in which a weight-average molecular weight Mw is from 150,000 to 300,000, and a melt viscosity Mv, measured at a temperature of 270° C. under a shearing speed of 122 sec⁻¹, satisfies Mv<6.2×10⁻¹⁵×Mw^{3.2}, has excellent machinability, and can be molded into a secondarily molded article, particularly a downhole tool member for petroleum drilling, by machining such as cutting, drilling, and shearing.

On the other hand, in the downhole tool member containing the polyglycolic acid resin composition, the downhole tool member, of Comparative Examples 1 to 3, containing the polyglycolic acid resin composition in which a weight-average molecular weight Mw is from 150,000 to 300,000, and a melt viscosity My (Pas), measured at a temperature of 270° C. under a shearing speed of 122 sec⁻¹, satisfies Mv<6.2×10⁻¹⁵×Mw^{3.2}, has a deformation occurring due to a heat treatment performed for stress relaxation and was unable to obtain a beautiful processed surface by cutting or shearing in some cases. In particular, it was found that the downhole tool member of Comparative Examples 1 to 3 has insufficient strength in a high temperature environment required for the use of the downhole tool member for petroleum drilling or the component thereof.

### INDUSTRIAL APPLICABILITY

Since the downhole tool member according to an embodiment of the present invention a downhole tool member containing a polyglycolic acid resin composition in which a weight-average molecular weight Mw is from 150,000 to 300,000, and a melt viscosity My (Pa·s), measured at a temperature of 270° C. under a shearing speed of 122 sec⁻¹, satisfies Mv<6.2×10⁻¹⁵×Mw^{3.2}, a secondarily molded article having a desired shape, particularly a solidification- and extrusion-molded article of degradable resin that has sufficient strength in a high temperature environment and that can be formed into a downhole tool member provided in an isolation plug, an isolation plug including the downhole tool member, and an isolation plug mandrel can be provided by subjecting the polyglycolic acid resin composition to machining such as cutting, drilling, and shearing. Thus, the solidification- and extrusion-molded article of polyglycolic acid of the present invention has high industrial applicability. Furthermore, in the manufacturing method according to an embodiment of the present invention, it is possible to provide a secondarily molded article, particularly a solidification- and extrusion-molded article of degradable resin having sufficient strength in a high temperature environment and properties suitable for machining to form a downhole tool member or component thereof for drilling and completion of petroleum recovery, that has reduced residual stress and excellent hardness, strength, and flexibility. Therefore, the manufacturing method for the solidification- and extrusion-molded article of degradable acid according to an embodiment of the present invention has high industrial applicability.

### REFERENCE SIGNS LIST

1 Mandrel
2 Seal member
3 Socket
4, 5 Cone
6a, 6b Slip
7 Load ring
8 Ball seat
9 Ball
10 Frac plug

1. (canceled)

2. A downhole tool member, wherein the polyglycolic acid resin composition has a weight-average molecular weight Mw from 150,000 to 300,000, and a melt viscosity My (Pa·s), measured at a temperature of 270° C. under a shearing speed of 122 sec⁻¹, satisfying the following: Mv<5.4×10⁻¹⁵×Mw^{3.2}.

3. The downhole tool member according to claim 2, wherein the polyglycolic acid resin composition, as a molded article molded from the polyglycolic acid resin composition, has a crushing strength of 40 kN or greater in a crushing test at 23° C.

4. The downhole tool member according to claim 2, wherein a rate of decrease in thickness is from 0.03 mm/h to 0.3 mm/h in water of 66° C.

5. The downhole tool member according to claim 2, wherein the polyglycolic acid resin composition is a composition containing a polyglycolic acid resin and a phosphorus compound of 700 ppm or greater relative to the polyglycolic acid resin.

6. The downhole tool member according to claim 2, which is a mandrel, a load ring, a socket, a cone, a ball, or a ball seat for a frac plug.

7. A method for manufacturing a downhole tool member according to claim 2, the method comprising injection-molding the polyglycolic acid resin composition.

8. A method for manufacturing a downhole tool member according to claim 2, the method comprising solidification-extrusion molding the polyglycolic acid resin composition.
